(19) United States
(12) Patent Application Publication
(10) Pub. No.: US 2008/0014044 A1
(43) Pub. Date: Jan. 17, 2008

(54) Spacing rivet, riveted joint and method for their production

(75) Inventors: Nicolas Begel, Chambery (FR); Hans-Joachim Dembowsky, Hamburg (DE); Johann-Haig Linden, Gutersloh (DE)

Correspondence Address: MARJAMA MULDOON BLASIAK & SULLIVAN LLP, 250 SOUTH CLINTON STREET, SUITE 300, SYRACUSE, NY, 13202, US

(73) Assignee: Bollhoff Verbindungstechnik GmbH, Bielefeld (DE)

(21) Appl. No.: 11/825,148

(22) Filed: Jul. 5, 2007

Related U.S. Application Data
(63) Continuation of application No. 11/800,941, filed on May 8, 2007.

(30) Foreign Application Priority Data
May 10, 2006 (DE) 10 2006 021 843.4

(51) Int. Cl. F16B 13/06; B21D 39/00

(52) U.S. Cl. 411/43; 29/509

(57) ABSTRACT

A riveted joint between two sheet-metal components spaced at a certain distance by means of a spacing rivet is described. The spacing rivet is immobilized on the one sheet-metal component by a flange and a first upset ridge and on the other sheet-metal component by a shoulder and a second upset ridge. A spacing section of the spacing rivet extends between the first upset ridge and the shoulder in order to keep the two sheet-metal components at a certain distance from each other. A spacing rivet and a method for producing this type of riveted joint are also described.

### CROSS REFERENCE TO RELATED APPLICATIONS

This application is a continuation of U.S. Ser. No. 11/800,941, filed May 8, 2007, which claims the priority of DE 102006021843.4 filed May 10, 2006, the entire contents of which are herein incorporated by reference.

### FIELD OF THE INVENTION

The present invention relates to a riveted joint between a first and second sheet-metal component spaced at a certain distance by means of a spacing rivet, a spacing rivet for this purpose as well as a method for producing the riveted joint.

### BACKGROUND OF THE INVENTION

Connections between two sheet-metal components by means of a blind-rivet nut are known. The blind-rivet nut normally consists of a hollow shaft, which is comprised of a hollow cylindrical upset section for forming an upset ridge and a reinforced thread section. The thread section has an internal thread, into which a tension mandrel of a mounting tool can be bored, in order to form the upset ridge by pulling through the tension mandrel. The two sheet-metal components are hereby clamped between a flange-like head of the blind-rivet nut and its upset ridge. The two sheet-metal components then rest directly against each other.

### SUMMARY OF THE INVENTION

the riveted joint, in which the two sheet-metal components are held at a certain distance from each other.

The invention and advantageous embodiments of the invention are defined in the claims.

In the case of a riveted joint designed according to the invention between a first and second sheet-metal component, the spacing rivet is immobilized on the first sheet-metal component by a flange and a first upset ridge and on the other sheet-metal component by a shoulder and a second upset ridge. The distance between the two sheet-metal components is determined by a spacing section of the spacing rivet, which is provided between the two upset ridges.

The spacing rivet for this type of riveted joint is made of a rivet shaft, which has a first sleeve-like upset section with an associated outer flange for forming the first upset ridge, a second sleeve-like upset section with an associated outer shoulder for forming the second upset ridge, and a spacing section between the two upset sections.

The spacing rivet designed according to the invention is an easily producible one-piece part, which enables a reliable and solid connection between the two sheet-metal components while maintaining a certain distance.

The riveted joint designed according to the invention is fast and easy to produce. There are two options:

In accordance with one option, the spacing rivet is inserted into the two sheet-metal components until its flange rests against the first sheet-metal component, and then the two upset sections, preferably in a continuous work process, are folded towards to upset ridges through a relative axial movement of the two sheet-metal components.

In accordance with the other option, the following work steps are provided, which are performed consecutively:

the spacing rivet is inserted into the first sheet-metal component until its flange rests against the first sheet-metal component,

the first upset section of the spacing rivet is folded towards the first upset ridge in order to immobilize the spacing rivet on the first sheet-metal component,

the spacing rivet is inserted into the second sheet-metal component until its shoulder rests against the second sheet-metal component, and

the second upset section of the spacing rivet is folded towards the second upset ridge in order to immobilize the spacing rivet on the second sheet-metal part.

In the last named case, the first two work steps can be performed by the supplier, who then delivers the first sheet-metal component with immobilized spacing rivet to the customer. The customer then performs the other work steps, through which the connection between the two sheet-metal components is established. The work effort required by the customer is reduced accordingly.

Other advantageous embodiments and further developments of the invention arise from the claims.

Exemplary embodiments of the invention are described in greater detail based on the drawings.

### BRIEF DESCRIPTION OF THE DRAWINGS

FIG. 1 shows a partially cut view of a spacing rivet with two sheet-metal components before the joint is produced; and

FIG. 2 shows a view according to FIG. 1 after the joint has been produced.

FIG. 3 shows a view according to FIG. 2 of a spacing rivet, which is surrounded by a bushing-like element.

### DETAILED DESCRIPTION OF A PREFERRED EMBODIMENT OF THE INVENTION

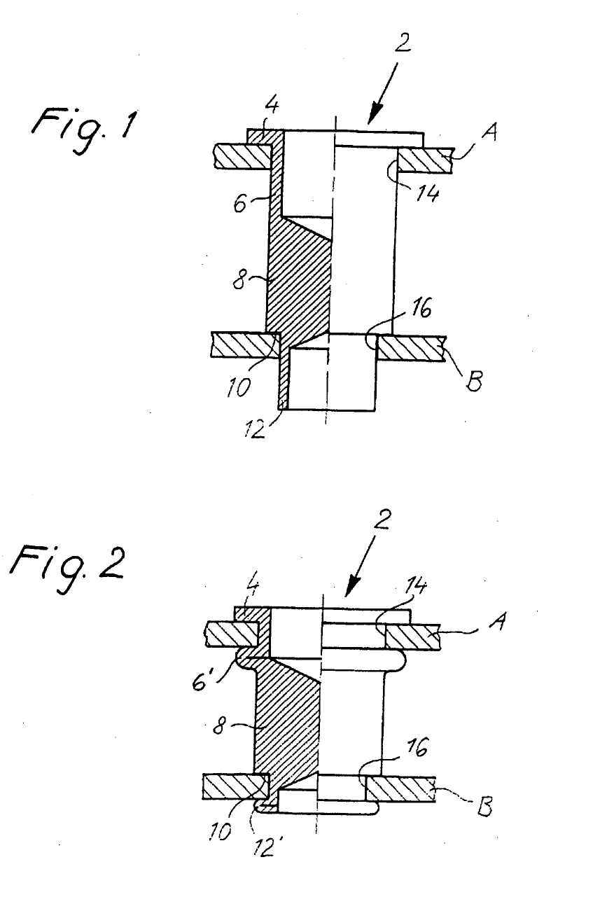

FIG. 1 shows two sheet-metal components A and B, which concern for example the two shells of a control arm in a shell construction. The two sheet-metal components A and B are permanently joined together by a spacing rivet 2, wherein a certain distance needs to be maintained between the two sheet-metal components.

The spacing rivet 2 is shown in FIG. 1 in its un-deformed state. It consists of a rivet shaft, which comprises an outer flange 4, a hollow cylindrical upset section 6, a spacing section 8 and a hollow cylindrical upset section 12, wherein a surrounding outer shoulder 10 is provided on the outer perimeter of the rivet shaft between the spacing section 8 and the upset section 12.

Similar to conventional blind-rivet nuts, the flange 4 is designed as a flat head, but could also be designed differently, e.g. as a countersunk head.

The upset portions 6 and 12 serve to form upset ridges 6′ and 12′ (FIG. 2), as will be explained in greater detail. In the exemplary embodiment shown, the upset section 6 has greater wall strength than the upset section 12, so that the upset section 12 is easier to deform than the upset section 6.

The spacing section 8 is solid and closed in the exemplary embodiment shown. It could also be hollow instead. However, in either case, it should be designed reinforced with respect to the upset sections 6 and 12, so that it is not deformed during the folding of the upset ridges 6′ and 12′.

In the exemplary embodiment shown, the spacing rivet 2 is designed round over its entire outer perimeter. However, it is also possible that it only be round on the outer perimeter in certain areas, for example in the area of the spacing section 8. Instead, it is also possible to design the outer perimeter of the rivet shaft to be non-circular at least in sections, e.g. multi-sided (square or hexagonal), elliptical or in any other non-circular manner.

As already mentioned, the primary function of the spacing rivet 2 is to maintain a distance between components A and B. Moreover, the spacing rivet 2 can also be designed such that it has a functional characteristic for performing an additional function. Thus, for example, it can be provided with a borehole, which is either smooth or provided with an internal thread. The spacing rivet can also be designed as a bolt with or without a thread. It could also be designed as a quick-connect mechanism.

Even if the punching rivet 2 can be provided with an internal thread for performing an additional function, an internal thread is not required to produce the upset ridges 6′ and 12′. In the exemplary embodiment shown, the inside of the punching rivet 12 is thus smooth.

The one-piece punching rivet 2 is made of a malleable material, which enables the production of the upset ridges 6′ and 12′. Steel, stainless steel, aluminum alloys, brass or similar materials, such as those used for blind-rivet nuts, can be used.

There are generally two options for producing the riveted joint shown in FIG. 2:

In accordance with one option, the spacing rivet 2 is inserted into aligning holes 14 and 16 of the two sheet-metal components A and B from one side until the flange 4 rests against sheet-metal component A and the shoulder 10 against sheet-metal component B (FIG. 1). The spacing rivet 2 is then compressed axially using a tool (not shown). For this purpose, the pressing device has e.g. two pressing bodies, one of which attaches to the flange 4 of the spacing rivet 2 and the other to the upset section 12 of the spacing rivet 2. The two pressing bodies of the pressing tool are then moved towards each other axially whereby the upset section 12 is first folded towards the upset ridge 12′ and then the upset section 6 towards the upset ridge 6′. During the upset process, there is a corresponding relative, axial movement between the sheet-metal components A and B so that the distance between the sheet-metal components A, B changes from the state in FIG. 1 by a corresponding amount to the state in FIG. 2. For example, the distance between the two sheet-metal components A, B decreases from approx. 15 mm (FIG. 1) to approx. 13 mm.

After the formation of the upset ridges 6′ and 12′, the sheet-metal component A is clamped between the flange 4 and the upset ridge 6′ and the sheet-metal component B is clamped between the shoulder 10 and the upset ridge 12′. The spacing section 8 ensures a solid and secure connection between the components A and B at the desired mutual distance.

In accordance with the other option, the spacing rivet 2 is first connected only with the sheet-metal component A. For this, the spacing rivet 2 is inserted into the hole 14 of the sheet-metal component A until the flange 4 rests against the sheet-metal component A. Then the upset section 6 is folded towards the upset section 6′ so that the spacing rivet 2 is permanently connected with the sheet-metal component A. The sheet-metal component A and the spacing rivet 2 can now be operated as one structural unit so that a supplier can deliver the structural unit in its current state to a customer.

The customer then performs the rest of the work steps to complete the riveted joint between the sheet-metal components A and B. For this, the upset section 12 of the spacing rivet 2 is inserted into the hole 16 of the sheet-metal component A until the sheet-metal component B rests against the shoulder 10. Then the upset section 12 is deformed into the upset ridge 12′ so that the sheet-metal component B is clamped between the shoulder 10 and the upset ridge 12. The riveted joint between the sheet-metal components A and B is thus complete. It follows that this manner of installation considerably decreases the customer's effort to produce the riveted joint.

In the exemplary embodiment shown in FIGS. 1 and 2, the holes 14, 16 in the components A and B are precast. However, it is also generally possible to provide the spacing rivet 2 with a cutting edge on the end turned away from flange 4. This cutting edge can then be used to punch out the hole 16 of the component B via a corresponding punching procedure during the setting of the rivet 2. Tolerance problems during the alignment of precast holes are hereby avoided.

It is also understood that the upset sections 6 and 12 can also be designed with the same wall strength so that in the case of the first option for producing the riveted joint the two upset ridges 6′ and 12′ are formed at the same time.

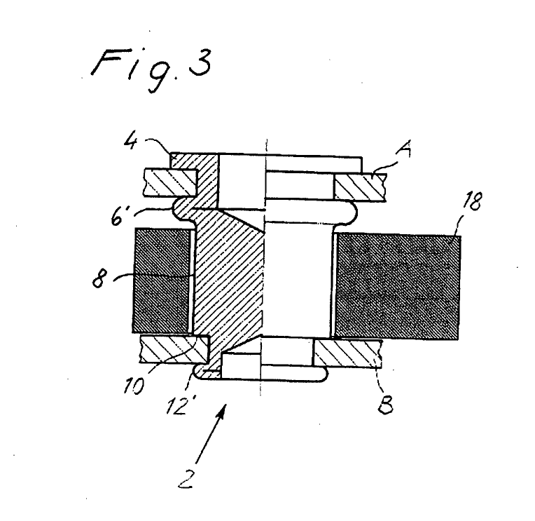

In the case of the exemplary embodiment shown in FIG. 3, the riveted joint between the spacing rivet 2 and the components A, B are identical to those in FIG. 2. The only difference is that the spacing section 8 of the spacing rivet 2 is surrounded by a bushing-like element 18. The bushing-like element 18 serves to perform other functions, e.g. as deflection roller, gear wheel, lever arm, etc. It is also possible to provide a bearing sleeve (not shown), which is effectively “riveted in” during the production of the riveted joint, in the space between the spacing section 8 of the spacing rivet 2 and the bushing-like part 18.

We claim:

1. Riveted joint between a first and second sheet-metal component spaced at a certain distance by means of a spacing rivet in the form of a rivet shaft, which has a flange and a first upset ridge for immobilization on the first component, a second upset ridge and a shoulder for immobilization on the second component as well as a spacing section between the upset ridges.

2. Riveted joint according to claim 1, wherein the flange is provided on one axial end of the spacing rivet and the second upset ridge is provided on the other axial end of the spacing rivet.

3. Riveted joint according to claim 1, wherein the rivet shaft of the spacing rivet is designed hollow in the area of the two upset ridges.

4. Riveted joint according to claim 3, wherein the rivet shaft of the spacing rivet in the area of the first upset ridge has a different wall strength than in the area of the second upset ridge.

5. Riveted joint according to claim 1, wherein the spacing section of the spacing rivet is designed reinforced with respect to the two upset ridges.

6. Riveted joint according to claim 1, wherein the spacing section of the spacing rivet is surrounded by a bushing-like element that can be pivoted on the longitudinal axis of the spacing rivet.

7. Riveted joint according to claim 6, wherein a bearing sleeve is arranged between the spacing section of the spacing rivet and the bushing-like element.

8. Spacing rivet for a riveted joint with a rivet shaft, which has a sleeve-like first upset section with an associated outer flange for forming a first upset ridge, a sleeve-like second upset section with an associated outer shoulder for forming a second upset ridge and a spacing section between the two upset sections.

9. Spacing rivet according to claim 8, wherein the flange is provided on one axial end of the spacing rivet and the second upset section is provided on the other axial end of the spacing rivet.

10. Spacing rivet according to claim 8, wherein the first upset section has a different wall strength than the second upset section.

11. Spacing rivet according to claim 8, wherein the spacing section is designed reinforced with respect to the two upset sections.

12. Spacing rivet according to claim 11, wherein the spacing section is solid and closed.

13. Spacing rivet according to claim 11, wherein the spacing section is hollow.

14. Spacing rivet according to claim 8, wherein the rivet shaft is designed threadless on the inside.

15. Spacing rivet according to claim 8, wherein it has a functional characteristic for performing an additional function.

16. Spacing rivet according to claim 8, wherein the rivet shaft on its outer perimeter is designed circularly at least in sections.

17. Spacing rivet according to claim 8, wherein the rivet shaft on its outer perimeter is designed non-circularly at least in sections.

18. Spacing rivet according to claim 8, wherein the rivet shaft has a cutting edge on the end turned away from the flange for punching a hole in the second component.

19. Method for producing a riveted joint according to claim 1 by means of a spacing rivet, said spacing rivet having a sleeve-like first upset section with an associated outer flange for forming a first upset ridge, a sleeve-like second upset section with an associated outer shoulder for forming a second upset ridge and a spacing section between the two upset sections, said method having the following steps:
the spacing rivet is inserted into the two sheet-metal components until its flange rests against the first sheet-metal component and its shoulder against the second sheet-metal component,
then the two upset sections of the spacing rivet are folded towards the two upset ridges.

20. Method according to claim 19, wherein the two upset sections are folded in a continuous working process towards the two upset ridges.

21. Method according to claim 19, wherein the first upset section is folded towards the first upset ridge through an axial relative movement of the two sheet-metal components.

22. Method for producing a riveted joint according to claim 1 by means of a spacing rivet, said spacing rivet having a sleeve-like first upset section with an associated outer flange for forming a first upset ridge, a sleeve-like second upset section with an associated outer shoulder for forming a second upset ridge and a spacing section between the two upset sections, said method having the following steps, which are performed consecutively:
the spacing rivet is inserted into the first sheet-metal component until its flange rests against the first sheet-metal component,
the first upset section of the spacing rivet is folded towards the first upset ridge in order to immobilize the spacing rivet on the first sheet-metal component,
the spacing rivet is inserted into the second sheet-metal component until its shoulder rests against the second sheet-metal component, and
the second upset section of the spacing rivet is folded towards the second upset ridge in order to immobilize the spacing rivet on the second sheet-metal component.
